(19) United States
(12) Patent Application Publication
(10) Pub. No.: US 2001/0035917 A1
(43) Pub. Date: Nov. 1, 2001

(54) Display apparatus

(75) Inventors: Sei Satake, Kanagawa (JP); Suehiro Nakamura, Tokyo (JP); Hirofumi Kanemaki, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SONY CORPORATION, TOKYO (JP)

(21) Appl. No.: 09/790,604

(22) Filed: Feb. 23, 2001

(30) Foreign Application Priority Data
Feb. 25, 2000 (JP) 2000-054436

(51) Int. Cl. H04N 5/44; H04N 9/64; H04N 5/63

(52) U.S. Cl. 348/730; 348/714; 348/553

(57) ABSTRACT

There is provided a display apparatus capable of assuredly conveying communicative information to viewers, the display apparatus comprising the following: display means for displaying video picture; switching means for turning power-source ON and OFF; and controlling means for controlling the display means to display communicative information thereon in place of the video picture during a period after the switching means executes an operation to turn off the power source until the power source is actually turned off.

### BACKGROUND OF THE INVENTION

1. Field of the Invention

The present invention relates to a display apparatus for displaying video picture.

2. Description of the Related Art

In recent years, a variety of display apparatuses incorporating diversified functions have been developed for displaying video picture including an electronic apparatus such as a television monitoring set as an example of a display apparatus conventionally being used. Such a conventional television monitoring set enables viewers to selectively view video picture of a desired program. However, inasmuch as a wide variety of commercial advertising programs are frequently broadcast at the beginning or on the way of proceeding with a regular TV program to oblige viewers to watch advertising programs shown on a TV screen, marketing publicity is promoted for specific products offered by individual enterprises sponsoring commercial advertising programs.

However, when such an undesired commercial advertising program is broadcast at the beginning or on the way of proceeding with a regular TV program as cited above, since any of TV viewers is obliged to wait for resumed broadcasting of the desired program for a certain duration, and yet, since an enjoyable program is interrupted, normally, TV viewers are inclined to change TV channels to avoid watching undesired commercial advertising programs. This in turn results in the lowered effect of publicity via broadcast commercial advertising programs.

### SUMMARY OF THE INVENTION

The object of the present invention is to solve the above problem by providing such a display apparatus capable of assuredly conveying communicative information to TV viewers.

According to an aspect of the present invention, there is provided a display apparatus comprising: displaying means for displaying video picture; switching means for turning power-source ON and OFF; a memory unit for storing data; and controlling means for reading data from the memory unit and displaying the read-out data on the display means; in which the controlling means controls the display means to display communicative information in accordance with the data stored in the memory unit during a period after the switching means executed an operation to turn off the power source until the power source is actually turned off.

According to another aspect of the invention, the display apparatus further comprises setting means for setting duration of time in which the communicative information is displayed by the displaying means. Or, the display apparatus further comprises storing means for storing data related to the communicative information; and the data related to the communicative information is stored in the storing means prior to shipment of the display apparatus.

In addition, according to another aspect of the invention, the display apparatus further comprises information-reading means for reading data related to the communicative information from an information storage medium which internally stores the data related to the communicative information.

Further, according to another aspect of the invention, the display apparatus further comprises radio communication means for acquiring the data related to the communicative information via radio communication. Alternatively, the display apparatus further comprises wire communication means for acquiring the data related to the communicative information via wire communication.

Further, in the display apparatus of the present invention, the communicative information comprises any of product information, service contents, and notification information, or a combination of the information contents.

According to the display apparatuses of the present invention, it is possible to assuredly convey communicative information to TV viewers at large.

### BRIEF DESCRIPTION OF THE DRAWINGS

The foregoing and other objects, features and advantages of the present invention will be apparent to those skilled in the art from the following description of the presently preferred exemplary embodiments of the invention taken in connection with the accompanying drawings, in which:

FIG. 1 is a simplified block diagram exemplifying a construction of a display apparatus according to a first embodiment of the present invention;

FIG. 2 exemplifies video picture displayed on a display unit shown in FIG. 1;

FIG. 3 exemplifies advertising contents displayed on the display unit shown in FIG. 1;

FIG. 4 is a flowchart for explanatory of serial operations of the display apparatus;

FIG. 5 is a simplified block diagram exemplifying a construction of a display apparatus according to a second embodiment of the present invention;

FIG. 6 is a simplified block diagram exemplifying a construction of a display apparatus according to a third embodiment of the present invention; and

FIG. 7 is a simplified block diagram exemplifying a construction of a display apparatus according to a fourth embodiment of the present invention.

### DESCRIPTION OF THE PREFERRED EMBODIMENTS

Referring now to the accompanying drawings, suitable forms for embodying the present invention are described below. It should be understood that, since the practical forms for implementing the present invention comprise such concrete examples for ideally realizing the present invention, a variety of proper technical limits are imposed. However, unless there is no description to particularly restrict scope of the present invention in the following description, scope of the present invention is by no means limited to the practical forms described below.

First Embodiment:

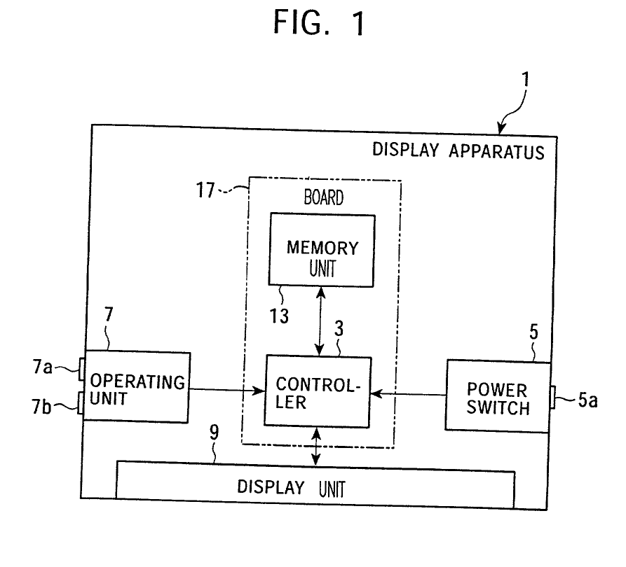

FIG. 1 is a simplified block diagram exemplifying a construction of a display apparatus according to a first embodiment of the present invention.

A display apparatus 1 is exemplified in FIG. 1, which is a television receiver for displaying video picture via reception of broadcast wave, for example. The display apparatus 1 itself is an electronic apparatus capable of turning power ON and OFF. Such an electronic apparatus may merely incorporate a function of displaying information. Aside from the above-cited one, the display apparatus 1 may also consist of a computer, a personal digital assistant (PDA), or a portable telephone or the like, for example. In other words, the display apparatus 1 includes overall apparatuses each incorporating such a function to display a wide variety of information such as video picture, graphics, texts, or the like, for example, and having the above-mentioned functions.

The display apparatus 1 is fitted with a display unit 9, a power switch 5, and a board 17, and yet, preferably, the display apparatus I further includes an operation unit 7.

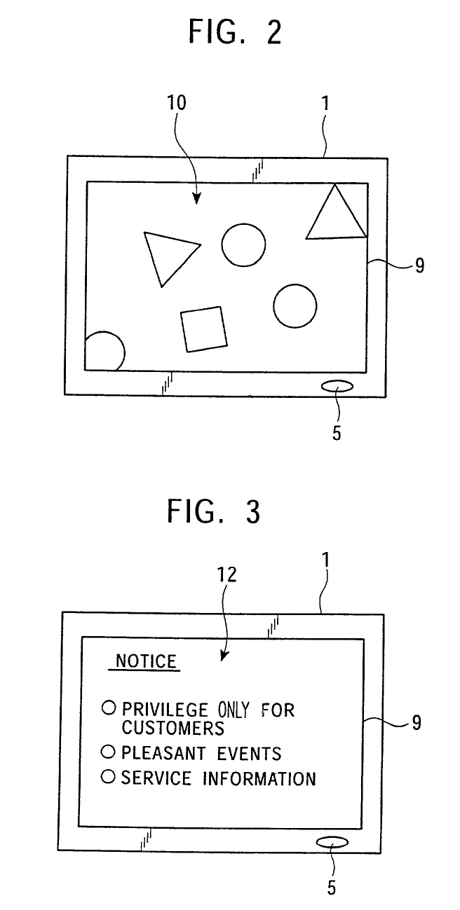

The display unit 9 is connected to the board 17 and controlled by circuits on the board. The display unit 9 displays video picture, which consists of a CRT display, an LCD display, a projector-type display, or the like, for example. The display unit 9 is disposed on the front surface of the display apparatus 1. While normally using the display apparatus 1, as shown in FIG. 2, a video picture 10 is displayed on the display unit 9 to enable viewers to visually enjoy the video picture 10. Further, it is so arranged that, when the viewer is about to turn off the power by depressing a button 5a of the power switch 5, advertising contents 12 shown in FIG. 3, for example, are displayed on the display unit 9.

As shown in FIG. 1, the power switch 5 is connected to the board 17, which constitutes a switching means for turning power-source of the display apparatus 1 ON and OFF. The power switch 5 is disposed at a certain part of a housing such as a cubic container of the display apparatus 1, for example, at a position on the front surface, at a position on either of both lateral surfaces, or at a position on the upper surface thereof. The following description is rendered on the assumption that, like the display unit 9, the power switch 5 is disposed on the front surface of the housing.

The board 17 is mounted with a memory unit 13 and a controller 3. Of these, the memory 13 comprises a main memory and an auxiliary memory each functioning to store data therein. The memory unit 13 consists of any of a RAM (random access memory), a ROM (read-only memory), and a hard disk, or it consists of a combination of these. The memory unit 13 incorporates a function to store data pertaining to communicative information to be conveyed to viewers. Concretely, the communicative information comprises the advertising contents to be conveyed visually or acoustically to viewers at large like the one shown in FIG. 3 by means of the advertising contents 12 for example.

The communicative information may comprise any of product information, contents of services, and notification information, or a combination of these. Such data pertaining to communicative information stored in the memory unit 13 is read by the controller 3 based on the request from the controller 3. When a viewer is just about to turn off the power for the display apparatus 1, then the read-out communicative information is displayed on the display unit 9.

The data pertaining to communicative information is previously recorded in the memory unit 13 prior to shipment of the display apparatus 1 to a distribution source, that is, during a manufacturing stage, for example. By previously storing communicative information in the memory unit 13 before enabling the viewer to utilize the display apparatus 1, it is possible for the display apparatus 1 to assuredly convey every communicative information to viewers at large without causing them to become aware of this.

The operating unit includes operation buttons 7a and 7b, and it is possible for the operating unit 7 to set communicative information to be displayed or not to be displayed on the display unit 9 using these buttons 7a and 7b when the viewer turns power-source of the display apparatus OFF. Accordingly, inasmuch as it is possible for the display apparatus 1 to set a display mode for displaying the communicative information or such an off-display mode at the time of turning power-source OFF in correspondence with the desire of individual viewers, this enables the viewers to be free from compulsorily viewing broadcast communicative information conforming to commercial advertising programs, thus freeing TV viewers from incurring sense of discomfort.

It is allowable for the operating unit 7 to activate an operation for setting a specific time for displaying communicative information on the display unit 9. Accordingly, by operating the operating unit 7, it is possible to optionally set duration of displaying communicative information on the display unit 9 whenever the individual viewers turn off the power-source of the display apparatus 1. As a result, even when causing the communicative information to be displayed on the display unit 9 at the time of turning off the power-source of the display apparatus 1, it is possible for the display apparatus 1 to effectively deliver the communicative information to the individual TV viewers without making them uncomfortable.

The display apparatus 1 realized by the present invention is constructed as described above. Next, an example of the operation of the display apparatus 1 according to the present invention is described below.

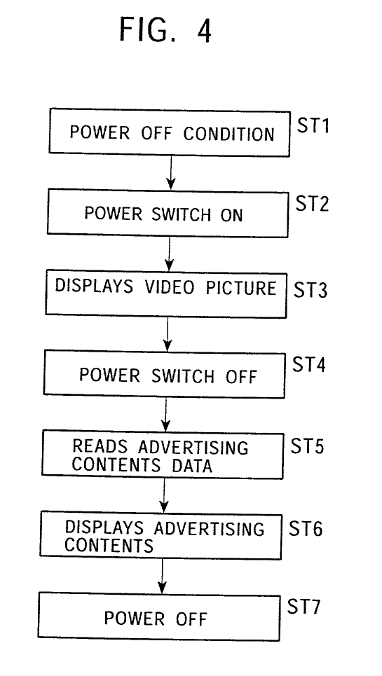

FIG. 4 represents a flowchart for exemplifying operation of the display apparatus 1 according to the present invention. First, the power of the display apparatus has been turned off (step ST1). Then, a viewer turns on the power of the display apparatus 1 by pressing the button 5a of the power switch 5 (step ST2), in order to display a video picture of a desired program on the display unit 9 of the display apparatus 1, as shown in FIG. 2 (step ST4). After continuously viewing the video picture 10 for a certain period of time, in order to discontinue to watch it, the viewer depresses a button 5a of the power switch 5 (step ST4). Simultaneously, a controller 3 of the display apparatus 1 shown in FIG. 1 reads data related to communicative information stored in a memory unit 13, for example (step ST5).

Then, in accordance with the read-out data related to communicative information, the controller 3 causes the display unit 9 to display advertising contents 12 shown in FIG. 3, for example, for a predetermined duration (step ST6). For example, as notifying items, “privilege for customers only”, or “pleasant events”, or “service information”, or the like, is displayed on the display unit 9. Not only these exemplified items, but a variety of communicative information may also be displayed thereon. In addition to the above examples, the communicative information may also include a procedure for affiliating with any banking corporation on a network or with a specific service provider, or such a method for participating in games executed via a network, or communicative information may also include “uniform resource locator” (URL) in the internet communication service which has been a focus of attention.

Next, after causing the display unit 9 to display the above advertising contents 12 for such a duration corresponding to a predetermined period of time, the controller 3 executes an operation to cause power source of the display apparatus 2 to be turned OFF, the power source thereof is turned off (step ST7). As mentioned earlier, display of the advertising contents 12 may be made effective or canceled via a setting operation to be executed by viewers.

According to the first embodiment of the present invention, since it is possible to display communicative information to viewers immediately before turning power OFF instead of displaying it on the way of proceeding with a desired regular TV program or between TV programs, it is possible for the display apparatus 1 to assuredly deliver communicative information without making the viewer uncomfortable caused by compulsory viewing of undesired advertising programs, thus resulting in the promotion of advertising effect.

Insofar as the display apparatus 1 is actually operated, it is imperative that an operation for turning power OFF be executed without fail. Because of this, even when a viewer frequently changes channels by utilizing operating function of a remote controller unit in order to avoid undesired viewing of commercially advertising programs and messages, it is assuredly certain that the viewer will see any of the communicative information at the time of turning off the power of the display apparatus 1. This in turn enables the display apparatus 1 to assuredly convey such commercially advertising communicative information to the viewers. Further, because of this function, it is expected that the display apparatus 1 of the present invention will become an effective communication device for delivering a variety of information to promote affiliation with new services including network services and the like from now on.

Second Embodiment:

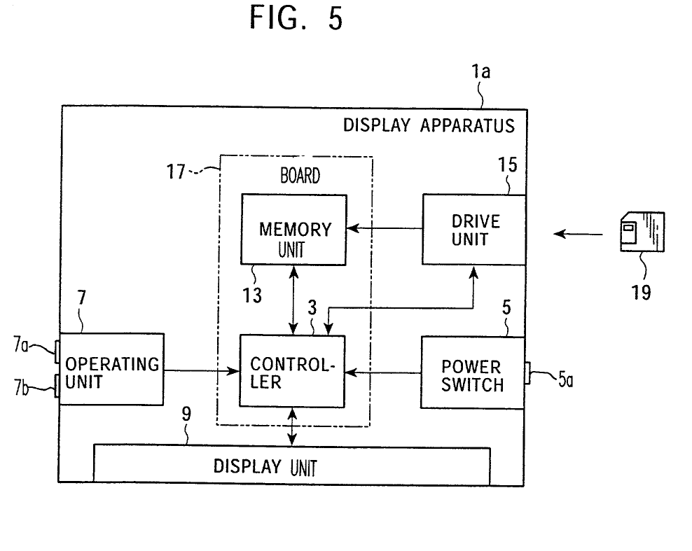

FIG. 5 represents a simplified block diagram of another display apparatus according to a second embodiment of the present invention.

The display apparatus according to the second embodiment is provided with such a construction and operating functions substantially identical to those of the above-referred display apparatus 1 shown in FIG. 1 to FIG. 4 at the portions designated via identical reference numerals, and thus, the following description solely refers to those points different from each other.

In contrast with the display apparatus 1 related to the first embodiment in which data pertaining to communicative information is previously stored in the memory unit 13, in the second embodiment, a display apparatus 1a acquires all the communicative information via an external source. The display apparatus 1a includes a drive unit 15 controlled by a controller 13, where the drive unit 15 is connected to a memory unit 13. Data related to the above-mentioned communicative information is stored in a storage medium 19. The storage medium 19 is detachable from the drive unit 15, and it is so arranged that the drive unit 15 at least reads such data recorded on the detachable storage medium 19. The drive unit 15 causes the memory unit 13 to internally store data read under the control of the controller 3. The storage medium 19 may be distributed to individual users as one of accessories or attachments at the time of shipment of the display apparatus 1a, and yet, the storage medium 19 may be distributed from time to time via postal delivery for sales promotion for example.

According to the second embodiment of the present invention, the display apparatus 1a achieves such a unique effect substantially identical to that is effected by the above display apparatus 1 of the first embodiment. In addition, by way of storing data related to a variety of communicative information in the storage media 19, it is possible for the display apparatus 1a to acquire the data related to communicative information to further make it possible to convey a wide variety of communicative information to TV viewers when each viewer turns power OFF. Accordingly, by way of distributing brand-new storage media to individual users of the display apparatus 1a from time to time, it is possible to constantly convey the updated communicative information to the users, i.e., TV viewers via the display apparatus 1a.

Third Embodiment:

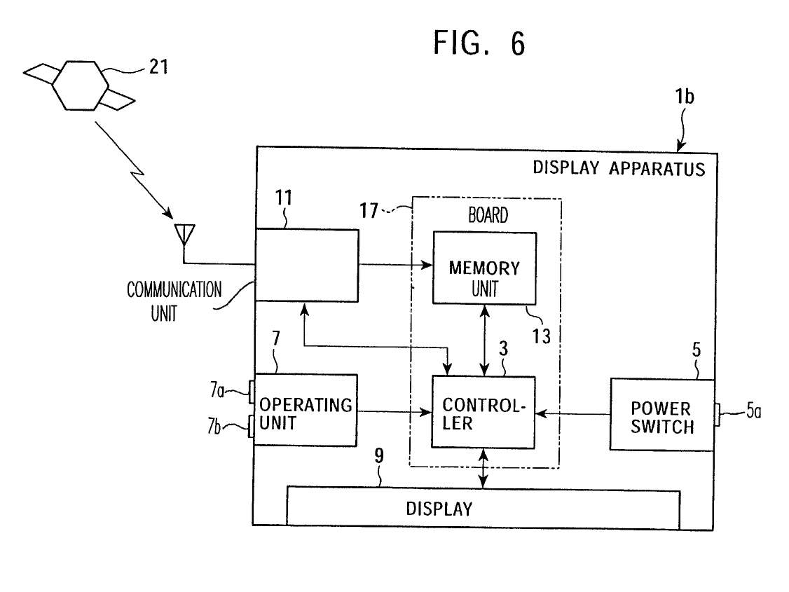

FIG. 6 represents a simplified block diagram of another display apparatus according to a third embodiment of the present invention.

The display apparatus according to the third embodiment of the present invention is provided with such a construction and such operating functions substantially identical to those of the display apparatus 1 according to the first embodiment at the portions designated by identical reference numerals, and thus, the following description solely refers to those points different from each other.

In contrast with the display apparatus 1 provided for the first embodiment in which communicative information is previously stored in a memory unit 13, a display apparatus 1b provided for the third embodiment acquires communicative information via an external source. The display apparatus 1b includes a communication unit 11 controlled by a controller 3, where the communication unit 11 is connected to a memory unit 13. The communication unit 11 includes such a function to receive a variety of data from a server (not shown) via a satellite station 21 using radio communication, and yet, the communication unit 11 is incorporated with a specific antenna. Under control of the controller 3, the communication unit 11 stores the received data in the memory unit 13. The satellite station 21 distributes broadcast wave from a communication satellite (CS) and a broadcasting satellite (BS) for example. Accordingly, the display apparatus 1b should desirably has such a function to receive CS broadcast and BS broadcast waves transmitted from the CS satellite or the BS satellite, respectively.

According to the third embodiment of the present invention, the display apparatus 1b generates such a unique effect identical to that is obtained by the display apparatus 1 of the first embodiment. In addition, by way of preparing a variety of data in a memory device positioned discretely from the display apparatus 1b, it is possible to constantly store a greater amount of data therein. Further, by way of preparing data of communicative information in a position separate from the display apparatus 1b, it is possible for individual sponsors of commercial advertisements to easily refresh the data contents, whereby making it possible to constantly convey the latest information to TV viewers at large.

Fourth Embodiment:

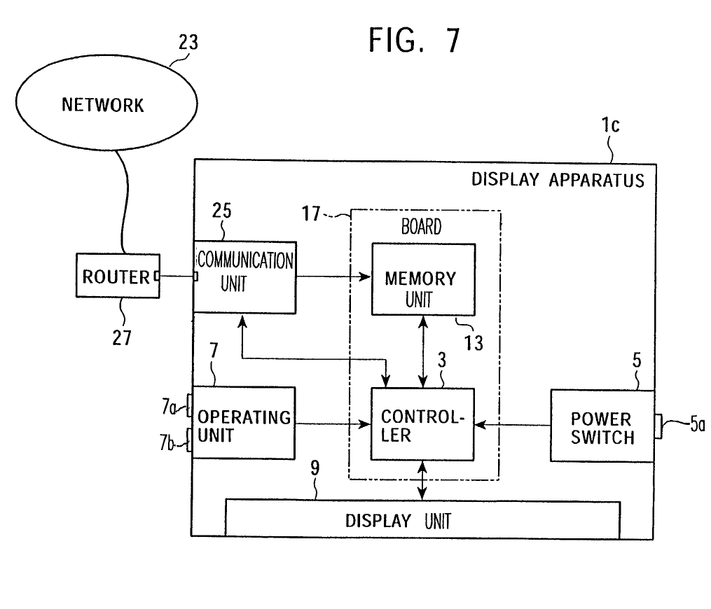

FIG. 7 represents a simplified block diagram of another display apparatus according to a fourth embodiment of the present invention.

The display apparatus according to the fourth embodiment of the present invention is provided with such a construction and operating functions almost being identical to those provided for the display apparatus 1b of the third embodiment at the portions designated by identical reference numerals, and thus, the following description solely refers to those points different from each other.

In contrast with the display apparatus 1b of the third embodiment which receives communicative information via radio communication, a display apparatus 1c provided for the fourth embodiment receives communicative information via wire communication. In place of the above communication unit 11 provided for the display apparatus 1b of the third embodiment, in the display apparatus 1c of the fourth embodiment, a communication unit 25 is connected to a memory 13, where the communication unit 25 is controlled by a controller 3.

The communication unit 25 has such a function to receive data from a server (not shown) by applying wire communication via a network 23. This communication unit 25 substantially consists of a network-card, for example, which is connected to a router 27 via a signal wire such as “10Base-T”, or the like. The router 27 is connected to the network 23. The network 23 itself consists of an Internet service network, or an intra-network, or a local-area-network (LAN), for example. The communication unit 25 stores data read under the control of the controller 3 in the memory 13.

According to the fourth embodiment of the present invention, it is possible to achieve such a unique effect identical to that is obtained by the third embodiment thereof.

It should be understood that the scope of the present invention is not solely limited to the above-described practical forms for implementing the present invention. It should also be understood that part of respective constructions based on all the above-described embodiments may be deleted or optionally combined with each other by way of differing from the above embodiments.

The above description has referred to the function of individual display apparatuses 1, 1a, 1b and 1c for displaying commercial advertisements by way of solely consisting of hardware. However, it is of course practicable to implement the display of commercial advertisement by applying software as well. In order to realize such a program including the above-referred advertisement displaying function, it is allowable to store the relevant program in a proper data storage medium such as “Compact Disc (CD)” (a registered trade name), or in a digital versatile disc (DVD), or in a semiconductor memory device such as “Memory Stick” (a registered trade name), for example. Further, the above-referred program may also be delivered to individual users of the display apparatus of the present invention via network communication media such as Internet services and digital satellite communication networks.

What is claimed is:

1. A display apparatus, comprising:
displaying means for displaying video picture;
switching means for turning power-source ON and OFF;
a memory unit for storing data; and
controlling means for reading data from said memory unit and displaying the read-out data on said display means, wherein:
said controlling means controls the display means to display communicative information in accordance with the data stored in the memory unit during a period after the switching means executed an operation to turn off the power source until the power source is actually turned off.

2. The display apparatus according to claim 1, wherein further comprising setting means for setting a duration of time in which the communicative information is to be displayed by said displaying means.

3. The display apparatus according to claim 1, further comprising storing means for storing data related to said communicative information, wherein said data related to communicative information is stored in said storing means prior to shipment of said display apparatus.

4. The display apparatus according to claim 1, further comprising information-reading means for reading data related to said communicative information from an information storage medium which internally stores said data related to said communicative information.

5. The display apparatus according to claim 1, further comprising a radio communication means for acquiring data related to said communicative information via radio communication.

6. The display apparatus according to claim 1, further comprising a wire communication means for acquiring data related to said communicative information via wire communication.

7. The display apparatus according to claim 1, wherein said communicative information comprises any of a product information, service contents, and a notifying information, or a combination of said information contents.
